(19) United States
(12) Patent Application Publication
(10) Pub. No.: US 2017/0139888 A1
(43) Pub. Date: May 18, 2017

(54) SYSTEM AND METHOD OF ANALYZING POLLING RESULTS AND GENERATING POLLING RESULTS OUTPUTS

(71) Applicant: STARTING BLOCK CAPITAL, WASHINGTON, DC (US)

(72) Inventors: Michael RAMLET, Washington, DC (US); Kyle DROPP, Washington, DC (US); Alex DULLIN, Hanover, NH (US)

(73) Assignee: STARTING BLOCK CAPITAL, WASHINGTON, DC (US)

(21) Appl. No.: 14/943,779

(22) Filed: Nov. 17, 2015

(51) Int. Cl. G06F 17/24; G06F 3/0484; G06F 3/0482; G06T 11/20; G06T 11/60

(52) U.S. Cl. CPC G06F 17/241; G06T 11/206; G06T 11/60; G06F 3/0482; G06F 3/04842; G06T 2200/24

(57) ABSTRACT

Systems and methods may analyze polling results and generate polling results outputs based on respondent characteristics, generating slide documents using one or more polling results outputs, saving and sharing poll results outputs, and performing trending analytics based on polls. A poll results output may be dynamically generated and modified by monitoring user-provided filter parameters. The system may overlay secondary information related to poll responses to augment the customizable view of the poll results. The poll results output may be starred by a user so that the user may later access the poll results. The poll results output may be shared by the user through social networking platforms, content sites, and email and other communication channels. The system may perform trending analytics on the polling results in order to detect and display trends related to polls.

### FIELD OF THE INVENTION

The invention relates to a system and method of analyzing polling results and generating polling results outputs based on respondent characteristics, generating slide documents using one or more polling results outputs, saving and sharing poll results outputs, and performing trending analytics based on polls.

### BACKGROUND OF THE INVENTION

Polls in which respondents provide a response, typically to a poll question, can provide valuable insight into the respondents' sentiment and thoughts relating to a poll topic. The poll question can be open-ended in which free-form responses are allowed or closed in which the respondent must select a response from among two or more choices (e.g., yes/no, excellent/good/average/below average/poor, etc.). Poll topics can be broad, such as “how is the economy doing” or “would you vote for the Republican party or the Democratic party” to more specific, such as “how do you think the job market is doing” or “which candidate do you prefer?”

Although valuable, poll results analytics can be cumbersome to perform. For instance, oftentimes it is difficult to identify a set of respondents from whom responses are focuses based on common characteristics (e.g., analyzing how males age 18 to 35 feel about a particular topic). Furthermore, dynamically updating visual displays of poll results (including determining how and where to overlay secondary information) based on real-time inputs can be difficult. Still further, analyzing polling data for trends can be valuable as well, but difficult to spot based on oftentimes large quantities of the polling data. Even when the poll results are analyzed and placed into a convenient format, it is difficult to save, share and consume such formats.

These and other drawbacks exist with polling system.

### SUMMARY OF THE INVENTION

The invention addressing these and other drawbacks relates to a system and method of analyzing polling results and generating polling results outputs based on respondent characteristics, generating slide documents using one or more polling results outputs, saving and sharing poll results outputs, and performing trending analytics based on polls.

For instance, a system may access poll results, perform analysis on the poll results responsive to user inputs, and generate one or more poll results outputs. The poll results outputs may include one or more output elements such as graphics, text, and/or other output elements. The poll result output may be saved as or otherwise included in an image file, a spreadsheet, a word processing document, a slide document (e.g., a PowerPoint® presentation graphics program document), a Portable Document Format document, and/or other file.

In some instances, the system may provide interfaces that allows the user to analyze poll results. For example, the system may provide an interface that includes inputs for obtaining filter parameters from a user. The filter parameters may specify which sets of poll results data to include, exclude, and/or combine with other poll results data to generate a poll results output.

In an implementation, the filter parameters may be used to filter in responses based on respondent characteristics (e.g., “positive” filters). For instance, a first filter parameter may specify that responses from female respondents should be used to generate a poll result element (such as a bar in a bar graph). In some instances, a second filter parameter may specify that responses from male respondents should be used to generate a poll result element (such as a bar in a bar graph). In some instances, different filters can be combined. For example, a first bar showing responses from female respondents may be generated and a second bar showing responses from male respondents may be generated. The first bar and the second bar may be combined into a single bar graph to differentiate the different responses for each set of respondents. Furthermore, different types of filter parameters may be combined to filter out responses. For instance, a first filter parameter may specify responses from males be used, and a second filter parameter may specify responses from those aged 18-25 should be used. When combined, the first filter parameter and the second filter parameter may be used to specify that responses from males aged 18-25 should be used.

In an implementation, the filter parameters may be used to filter out responses based on respondent characteristics (e.g., “negative filters”). For instance, a first parameter may be used to specify that responses from respondents having certain characteristics not be used. For instance, a filter parameter may specify that responses from respondents who are over the age of 45 should not be used. Such negative filter parameters may be combined with other negative filters as well, and may be combined with positive filters.

The filters may be applied in real-time (e.g., upon receipt of the filters and not saving the filters for later application) to a poll result output. For instance, using the system, a user may dynamically generate graphs, charts, text, etc., of filtered poll results in real-time.

In an implementation, the system may overlay secondary information onto a poll results output. For instance, graphical representations or text associated with the secondary information may be overlaid onto a graph or other poll result output. The secondary information may augment the graph with additional information related to the poll results, but not be a response to the poll results. For instance, the secondary information may include economic data that is overlaid onto a poll relating to respondents' view of the President's handling of the economy. Although the economic data is not a response from a respondent, it is related to the responses and may augment the responses represented in the poll result output.

In an implementation, the system may provide an interface to generate a document that includes a poll result output. For example, a user may use the system to generate a slide document that includes one or more poll results outputs, which may themselves be customized by the user. In this manner, the system may generate a slide document that includes graphics, text, and/or other poll results outputs based on inputs from a user.

In an implementation, the system may provide an interface for the user to “star” or save a poll result output (whether the output is included in a word processing document, slide document, etc.) in association with user identifying information. In this manner, a user may use the system to generate poll results outputs and save them for later consumption.

In an implementation, the system may provide an interface for the user to share a poll result output. For instance, a user may post the poll result output to a social media account, send the poll result output to a content site (e.g., a news media site), send the poll result output via a communication channel (e.g., email, MMS message, etc.), and/or otherwise cause the poll result output to be transmitted over a network.

In an implementation, the system may perform trend analytics on the poll results data. For instance, the system may determine trends that indicate a popularity of a given poll topic, a set of poll topics, a subject matter of poll topics (e.g., politics-related, economy-related, technology-related, etc.) based on a number of times that each have been accessed, saved or shared, etc. In this manner, the system may determine what types of poll results are popular among users or entities that generate poll result outputs using the system.

In some instances, the system may determine trends related to poll results themselves. For instance, the system may determine, from the poll results data, that sentiment relating to a topic is increasing, decreasing, or remaining the same (statistically speaking) for a given time period. For instance, the system may detect an upward (or downward) trend in consumer confidence over the last six months by analyzing polling results related to consumer confidence within the last six months.

Whichever type of trends are determined, the system may cause a poll result output to be generated that illustrates the trend. For instance, a poll result output may be generated that includes a graph of the trend over time. In some of these instances, the trend may be compared to a trend or other poll results from a prior point in time. For instance, the trend may be compared to consumer sentiment from the same period of time from a prior year, and both sets of trends or data may be overlaid onto a single poll result output for comparison.

In an implementation, the system may determine trends based on respondent demographics (e.g., gender, residence location, etc.), geography pertaining to a poll (e.g., poll questions related to different geographic locations), and/or other characteristic of the poll data.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system for processing poll results, according to an implementation of the invention.

FIG. 2 illustrates a polling analytics computer system for analyzing poll results and generating poll results outputs, according to an implementation of the invention.

FIG. 3 illustrates a flow diagram of a process for analyzing poll results and generating poll results outputs, according to an implementation of the invention.

FIG. 4 illustrates a flow diagram of a process for generating a display of secondary information overlaid onto poll results, according to an implementation of the invention.

FIG. 5 illustrates a flow diagram of a process for dynamically updating a display of poll results based on parameter parameters, according to an implementation of the invention.

FIG. 6 illustrates a flow diagram of a process for dynamically generating a slide document based on selectable polls, according to an implementation of the invention.

FIG. 7A illustrates a channel through which the poll results output may be presented to a user, according to an implementation of the invention.

FIG. 7B illustrates a channel through which the poll results output may be presented to a user, according to an implementation of the invention.

FIG. 8 illustrates a screenshot of a user interface for providing selectable poll topics, according to an implementation of the invention.

FIG. 9 illustrates a screenshot of a user interface for providing a display mode of a poll results output, according to an implementation of the invention.

FIG. 10 illustrates a screenshot of a user interface for providing a display mode of a poll results output based on respondent characteristics, according to an implementation of the invention.

FIG. 11 illustrates a screenshot of a user interface for providing a chart display mode for providing a poll results output, according to an implementation of the invention.

FIG. 12 illustrates a screenshot of a user interface for providing a map display mode for providing a poll results output, according to an implementation of the invention.

FIG. 13 illustrates a screenshot of a user interface for generating slide documents that include poll result outputs, according to an implementation of the invention.

### DETAILED DESCRIPTION OF THE INVENTION

The invention described herein relates to a system and method of processing poll results. The system may access poll results, perform analysis on the poll results responsive to user inputs, and generate one or more poll results outputs. The poll results outputs may include one or more output elements such as graphics, text, and/or other output elements. The poll result output may be saved as or otherwise included in an image file, a spreadsheet, a word processing document, a slide document (e.g., a PowerPoint® presentation graphics program document), a Portable Document Format document, and/or other file.

In some instances, the system may provide interfaces that allows the user to analyze poll results. For example, the system may provide an interface that includes inputs for obtaining filter parameters from a user. The filter parameters may specify which sets of poll results data to include, exclude, and/or combine with other poll results data to generate a poll results output.

Analyzed poll results may be presented in the form of a poll result output. The poll result output may include one or more output elements such as graphics, text, and/or other output elements. The poll result output may be output as an image file, a spreadsheet, a word processing document, a slide document (e.g., a PowerPoint® presentation graphics program document), a Portable Document Format (“PDF”), and/or other type of output format.

Exemplary System Architecture

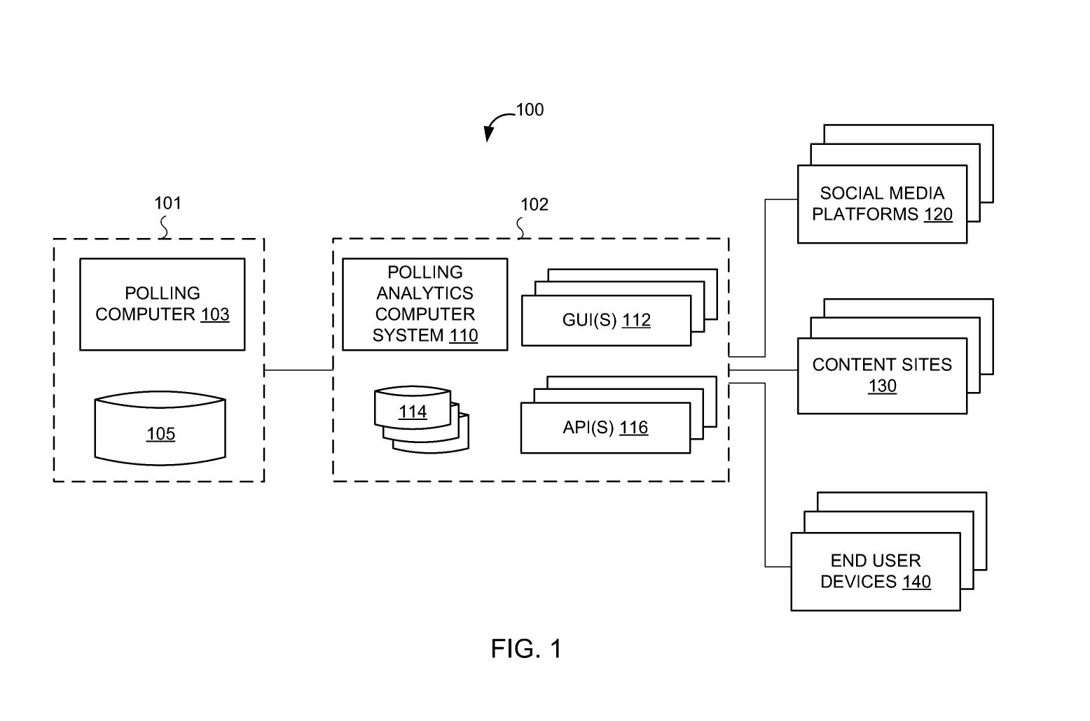

FIG. 1 illustrates a system 100 for processing poll results, according to an implementation of the invention. In an implementation, system 100 may include a polling system 101, a polling analytics system 102, one or more social media platforms 120, one or more content sites 130, one or more end user devices 140, and/or other components.

Polling system 101 may include a polling computer 103, a poll database 105, and/or other components. Polling computer 103 may be used to conduct polls and store the results of such polls using poll database 105. In some instances, the polls may be conducted through live-operators who ask poll questions to respondents and enter responses through their own computers, which communicate the responses to polling computer 103. In other instances, the polls may be conducted automatically, through the use of online forms (e.g., websites through which questions may be posed and responses collected), telephone (e.g., Interactive Voice Response systems), and/or other automated or semi-automated systems through which poll responses are provided to polling computer 103. Whichever manner is used to conduct a poll, polling computer 103 may store the responses in poll database 105.

In some instances, polling computer 103 may also store, in poll database 105, one or more characteristics of the respondents, if such characteristics are known. The characteristics may include, without limitation, an age, ethnicity, gender, residence address (locality, country, etc.), political party affiliation, religion, income, and/or other characteristics. Polling computer 103 may be aware of the characteristics before poll questions are posed to the respondent (e.g., when the respondent is already known to polling computer 103) or afterward (e.g., when the respondent is prompted to provide one or more characteristics). Of course, some characteristics may be known beforehand while others are discovered afterward. In any event, polling computer 103 may store an association of each of the characteristics of a respondent in a respondent profile so that a given respondent's characteristics may be looked up. Alternatively or additionally, each response to a poll question may be stored in association with information that identifies the respondent and/or the characteristics of the respondent. In this manner, each response may be stored in association with a demographic or other characteristic of the respondent who provided the response. Polling computer 103 may store the associations in poll database 105.

Polling analytics system 102 may obtain poll results from polling system 101 to analyze the poll results as described herein. The poll results may be pushed to or pulled by polling analytics system 102. In addition, in some instances, polling analytics system 102 may request certain polls to be conducted by polling system 101. In these instances, polling analytics system 102 may generate a polling specification that includes one or more polling parameters used to specify poll questions to be asked (e.g., questions and multiple-choice answers or open-ended answers), one or more respondent parameters that seek particular target respondents (e.g., age, gender, etc., of target respondents), and/or other parameters. Polling system 101 may then conduct the requested poll in response to and based on the polling specification and provide (or make available) the poll results, which may be analyzed by polling analytics system 102.

In some instances, polling analytics system 102 may provide analyzed poll results to social media platforms 120. Such platforms may include, without limitation, FACEBOOK, TWITTER, INSTAGRAM, YOUTUBE, and/or other social networks that generally provide user-generated content for consumption by other users. Alternatively, or additionally, polling analytics system 102 may provide analyzed poll results to content sites 130 that provide the analyzed poll results typically with other content. Such content sites may include news sites, weather sites, sports-related sites, shopping/electronic commerce sites, search engine sites, multimedia entertainment providers (e.g., video services), and/or other sites.

The third party platforms (e.g., social media platforms 120, content sites 130, etc.) may incorporate the poll result outputs into their respective assets. For instance, a news organization may incorporate a poll result output generated by polling analytics system 102 on its news website. Users or others (including organizations) may post certain poll result outputs directly to their social media account/homepage. Shopping sites may provide poll result outputs alongside reviews or other product information. Search engines may provide poll result outputs alongside search results to indicate users' indications of relevance of certain search results corresponding to certain search terms (as indicated by poll results, for example). Other examples of uses of the system will be apparent to those having skill in the art as well, based on the disclosure provided herein.

In some implementations, analyzed poll results may be accessed by end users using end user devices 140. For instance, users may obtain poll result outputs, then view and/or save them locally to their end user devices 140 (e.g., via GUIs 112 generated by polling analytics computer system 110), generate presentation documents that include poll results, post poll result outputs to their social media accounts using end user devices 140, and/or otherwise interact with the system using end user devices 140. The analyzed polling results and/or the polling results themselves may be stored in one or more databases, such as database(s) 114.

In an implementation, Application Programming Interfaces (APIs) 116 may include various APIs for use by third parties (e.g., social media platforms 120, content sites 130, etc.) to request different poll result outputs from polling analytics system 102. In these instances, polling analytics system 102 may expose external APIs 116 for use by third parties to access/request poll result outputs provided by polling analytics system 102. In this manner, such third parties may request and obtain poll result outputs for inclusion into their respective sites.

In an implementations, some APIs 116 may be used internally to access and interface with third parties. For instance, APIs 116 may be used to provide content to user's social media accounts. In this instance, polling analytics system 101 may obtain a user's credentials and authorization to post content to the user's social media account. Alternatively, polling analytics system 101 may use a given social media platform's API to facilitate logging into the user's social media account.

In an implementation, some of the foregoing APIs 116 may include various rules for formatting content. For instance, a given social media site may take images in a particular format while another site may take images in another format. APIs 116 may store rules that specify which format should be provided for a given recipient (whether the recipient is a user, an entity, a third party platform such as a social media platform 120, content site 130, etc.).

Having described a high level overview of the system, attention will now be turned to a description of polling analytics computer system 110.

Analyzing Poll Results and Generating Poll Result Outputs

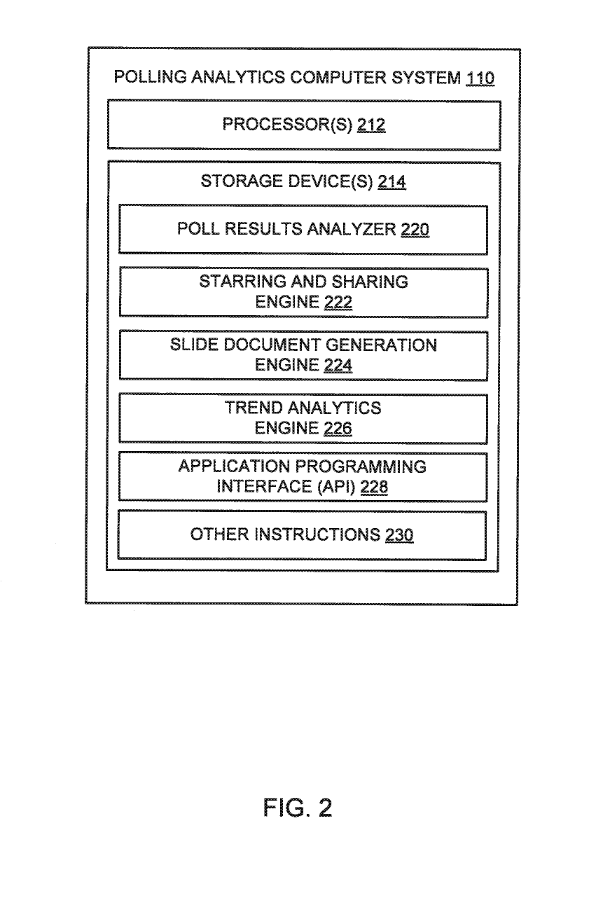

FIG. 2 illustrates a polling analytics computer system 110 for analyzing poll results and generating poll results outputs, according to an implementation of the invention. Polling analytics computer system 110 may be configured as a server (e.g., having one or more server blades, processors, etc.), a personal computer (e.g., a desktop computer, a laptop computer, etc.), and/or other device that can be programmed to analyze and provide poll results.

Polling analytics computer system 110 may include one or more processors 212 (also interchangeably referred to herein as processors 212, processor(s) 212, or processor 212 for convenience), one or more storage devices 214 (which may store various instructions described herein), and/or other components. Processors 212 may be programmed by one or more computer program instructions. For example, processors 212 may be programmed by a poll results analyzer 220, a starring and sharing engine 222, a slide document generation engine 224, a trend analytics engine 226, an Application Programming Interface (API) 228, and/or or other instructions 230 that program polling analytics computer system 110 to perform various operations, each of which are described in greater detail herein. As used herein, for convenience, the various instructions will be described as performing an operation, when, in fact, the various instructions program the processors 212 (and therefore computer system 110) to perform the operation.

In an implementation, poll results analyzer 220 may access the poll results and generate one or more poll result outputs. Poll results analyzer 220 may access and analyze the poll results either on-demand (e.g., when a user wishes to analyze and view poll results) or automatically access and analyze the poll results without being specifically requested by a user to do so (e.g., when the poll results are made available or at other times). For instance, polling system 101 may inform polling analytics system 102 that new poll results are available. Responsive thereto, polling analytics system 102 may begin analyzing the poll results (as described herein) or otherwise add the new polling results to a queue for such analysis to take place in batches (e.g., hourly, nightly, etc.).

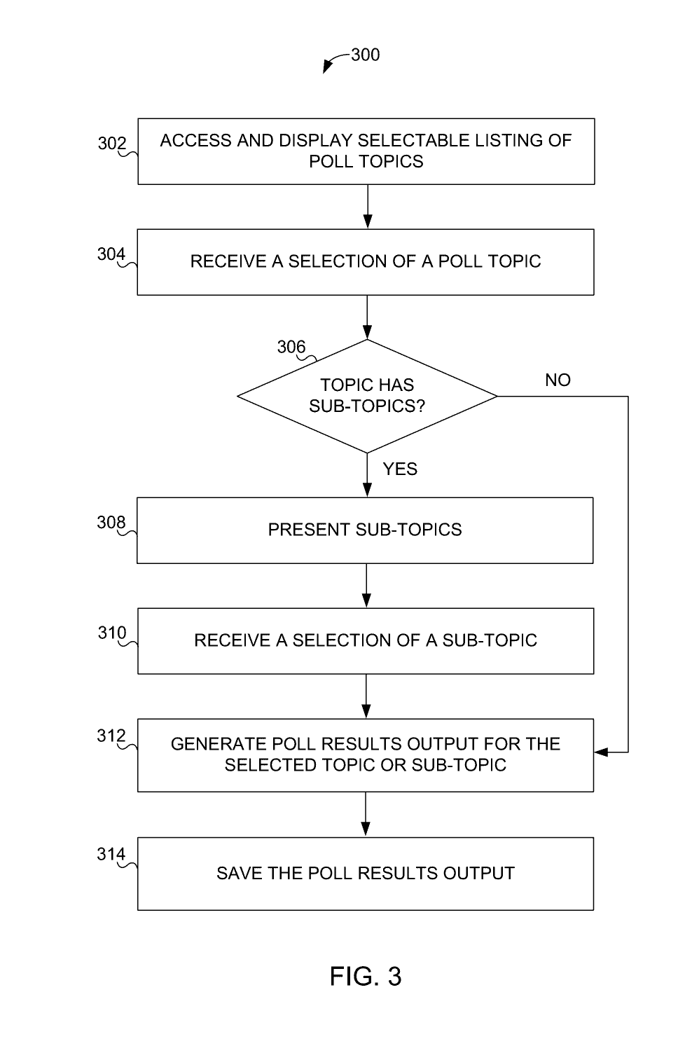

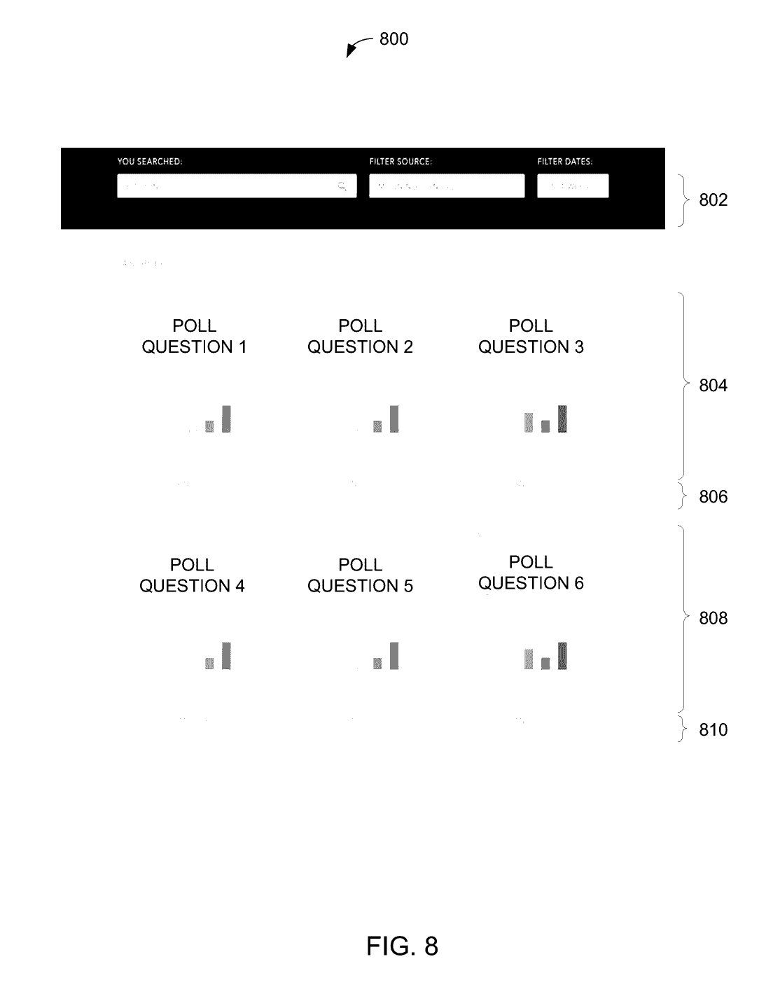

FIG. 3 illustrates a flow diagram of a process 300 for analyzing poll results and generating poll results outputs, according to an implementation of the invention. For instance, a given display mode is illustrated in each of FIGS. 8-12. Process 300 may be performed by poll results analyzer 220 and/or other component of system 100.

In an operation 302, process 300 may include accessing and displaying a selectable listing of poll topics. For instance, poll topics available from polling system 101 may be accessed and displayed for selection by a user. In some implementations, the selectable listing of poll topics may result from a search of topics. For instance, referring to FIG. 8, section 802 allows one or more search parameters, such as search terms/keywords, date/time parameters (e.g., of when poll results were obtained, when poll results were analyzed, a date/time to which the poll relates—such as poll questions relating to the President's performance during a given time period, etc.), and/or other search parameters.

Process 300 may include executing the search based on the search parameters. The search may be executed on poll results from polling system 101 and/or based on analyzed poll results from polling analytics system 102 (e.g., previously saved poll result outputs). The search may use conventional keyword matching on topics, sub-topics, poll source, poll respondent demographics, and/or other information related to the poll results. Results of the search may be presented in sections 804, 808. Of course, sections 804, 808 may include listings of poll topics unrelated to a search as well (e.g., a listing of all available poll topics).

In an operation 304, process 300 may include receiving a selection of a poll topic. For instance, referring to FIG. 8, a user may select the “ANALYZE” interface member (e.g., button) presented at sections 806, 810 for a corresponding topic.

In an operation 306, process 300 may include determining whether the poll topic includes sub-topics. If the selected poll topic includes sub-topics, in an operation 308, process 300 may include presenting the sub-topics for selection by the user.

In an operation 310, process 300 may include receiving a selection of a sub-topic. Such selection may be made in a manner similar to selecting a poll topic. Although not illustrated in FIG. 3, sub-topics may themselves include other selectable sub-topics, may be presented for selection by the user until all sub-topics have been traversed.

In an operation 312, process 300 may include generating a poll results output for the selected topic or sub-topic. The poll results output may be generated based on analysis that has been performed beforehand (e.g., predefined) or on-demand at the time of the request to analyze the selected topic or sub-topic (e.g., when the “ANALYZE” button was selected).

In an operation 314, process 300 may include saving the poll results output. For instance, a poll result output may be saved for later viewing. Alternatively or additionally, the topic or sub-topic may be saved for later viewing, in which case the poll results presentation may be generated based on the saved topic or sub-topic (and/or parameters used to generate the poll results presentation). The saved poll results outputs may be stored in association with a user identifier so that a given user may save one or more poll results outputs and/or poll topics/sub-topics for later viewing or analysis.

Overlaying Secondary Information onto Poll Results

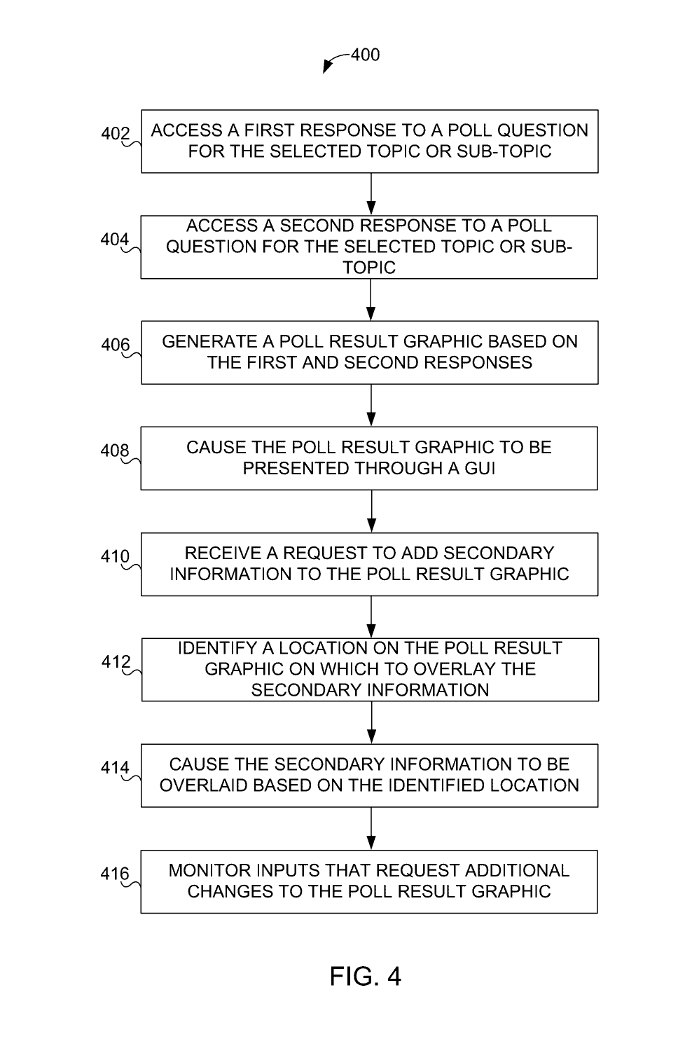

FIG. 4 illustrates a flow diagram of a process 400 for generating a display of secondary information overlaid onto poll results, according to an implementation of the invention. Process 400 may be performed by poll results analyzer 220 and/or other component of system 100. The secondary information may relate to the poll results, but may not be a response to a poll question. For instance, the poll may relate to how the President is handling the economy. The secondary information may include economic indicators, such as stock market activity, consumer sentiment, unemployment figures, gross domestic product, and/or other economic information that relates to the poll (e.g., the economy), but is not a response to a poll question. In this manner, the secondary information overlaid onto the poll result output may provide a more robust view of the poll results.

Furthermore, when the secondary information includes objective indicators (as in the economic indicators example), the objective information may be compared to the (potentially) subjective nature of the poll responses. Of course, the secondary information may include subjective information as well. For instance, the secondary information may include poll responses related to how a previous President handled the economy so that the previous and current Presidents may be compared on the economy (or respondents' view thereof). Other secondary information may be similarly overlaid onto poll results.

In an operation 402, process 400 may include accessing a first response to a poll question relating to a particular topic, the first response being stored in a physical memory in association with first respondent information that includes a plurality of first characteristics of a first respondent from which the first response was received.

In an operation 404, process 400 may include accessing a second response to the poll question, the second response being stored in the physical memory in association with second respondent information that includes a plurality of second characteristics of a second respondent from which the second poll questionnaire response was received.

In an operation 406, process 400 may include generating a poll result output based on the first response and the second response.

In an operation 408, process 400 may include causing the poll result output to be presented via a graphical user interface.

In an operation 410, process 400 may include receiving a request to add secondary information to the poll result output.

In an operation 412, process 400 may include identifying a location on the poll result output on which to overlay the secondary information based on information presented on the poll result output. Such location may depend on various factors such as, without limitation, the size of the poll result output, the time scale, and/or other factors. For instance, a given poll (or plurality of polls) may ask respondents how the President handled unemployment at different months and economic indicators for those months may be aligned accordingly in the poll result output.

In an operation 414, process 400 may include, responsive to the request to add the secondary information, causing the secondary information to be overlaid onto the poll result output based on the identified location. Causing the secondary information to be overlaid onto the poll result output may include generating a new poll result output with the secondary information, updating the poll result output to include the secondary information, or overlaying a new presentation corresponding to the secondary information onto the poll result output. Whichever manner is used to overlay the secondary information onto the poll result output, process 400 may include generating the poll result output and providing the poll result output to the end user device 140 (or whichever device will be viewing or obtaining the poll result output) and/or may provide instructions to the end user device 140 (or other device) that causes the receiving device to render the poll result output.

In an operation 416, process 400 may include determining whether further requests to change the modified poll result output is received. For instance, process 400 may monitor inputs at a GUI 112 through which a poll presentation is presented to determine whether additional or different parameters have been requested to change the mode (e.g., from a map mode to a chart mode) of the poll result output or add additional filter parameters (e.g., view demographics). In an implementation, process 400 may include causing instructions to be provided to the end user device that causes one or more further requests to change the poll result output to be received and processed to further update the poll result output upon receipt of the one or more further requests. For instance, such updates may be made in real-time upon receipt of the one or more further requests such that the further requests are not stored and later acted upon, but rather acted upon receipt of the further requests.

As additional or different parameters are applied, process 400 may dynamically change, update, or otherwise generate a new poll result output based on the additional or different parameters. In some instances, the inputs may be received at end user device 140 (or other device) and passed to polling analytics computer system 110, in which case the polling analytics computer system 110 processes the request and overlays secondary information onto the poll result output as described herein. In other instances, the inputs may be received at end user device 140 (or other device), which uses instructions (e.g., JAVASCRIPT or other client-executed scripts/code) provided from polling analytics computer system 110 to re-render the display accordingly.

Generating Dynamically Changing Views of Poll Results

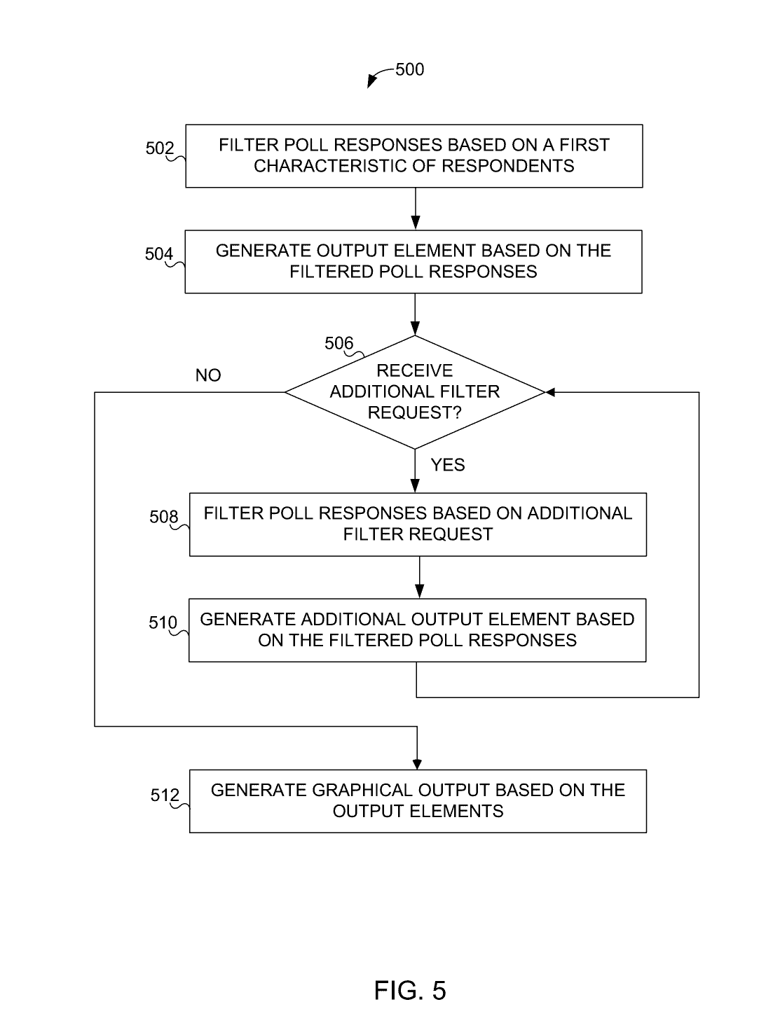

Once generated (whether or not with secondary information overlaid thereon), a display of poll results may be dynamically updated based on one or more filter parameters. FIG. 5 illustrates a flow diagram of a process 500 for dynamically updating a display of poll results based on filter parameters, according to an implementation of the invention. Process 500 may be performed by poll results analyzer 220 and/or other component of system 100.

In an operation 502, process 500 may include filtering poll responses based on a first characteristic of respondents. For instance, poll responses from a first demographic of respondents may be filtered (from the set of all poll responses) and presented as a first output element (e.g., a first bar on a bar graph). Poll responses from a second demographic of respondents may be filtered and presented as a second output element (e.g., a second bar on the bar graph). Other characteristics of respondents may be similarly filtered and presented. Alternatively or additionally, poll responses from respondents having a given characteristic may be omitted from being displayed. Furthermore, two or more characteristics of respondents may be combined in different ways. For instance, poll responses from males (first characteristic) between the ages of 18-32 (second characteristic) may be filtered in to create a output element or may be filtered out to be omitted from being displayed. Other characteristics of respondents may be similarly combined as well.

In an operation 504, process 500 may include generating an output element based on the filtered poll responses. In an operation 506, process 500 may include determining whether additional filter requests have been made. For instance, a user may formulate particular sets of filters to analyze poll results based on certain characteristics of respondents and add (or not) additional filters to apply.

If a further filter request is received, process 500 may include filtering poll responses based on the additional filter request in an operation 508 and updating the polling results output accordingly in an operation 510. Such updates may include adding an additional output element to, removing an output element from, or modifying an output element on the poll results output.

In an operation 512, process 500 may include generating and causing the poll results output to be provided. For instance, process 500 may include causing the poll results output to be transmitted to a remote device, such as end user device 140. In other instances in which end user device 140 generates the poll results output (e.g., based on instructions from polling analytics computer system 110), end user device 140 may display the poll results output.

Saving Favorites and Sharing Poll Results

In an implementation, starring and sharing engine 222 may cause a given poll result output to be stored in association with a user who wishes to save the output. For instance, a user may wish to save a graph relating to a particular poll question. In response, starring and sharing engine 222 may store the graph in association with the user. For instance, starring and sharing engine 222 may store a database association (e.g., a link) between the graph and user identifying information. In this manner, the graph and other saved poll result outputs may be saved in association with the user so that the user may later recall the saved graph (and other saved poll result outputs). Alternatively or additionally, information used to generate the poll result output may be stored in association with the user. For instance, the poll result topic and any filters/parameters used to generate the graph may be stored in association with the user so that the graph may be later generated when recalled.

In an implementation, starring and sharing engine 222 may share a given poll result output via a network. For instance, a poll result output may be shared to a social media platform 120, a content site 130, another user (e.g., through electronic mail, Multi-media Messaging Service message, etc.), and/or other communication channel. For instance, a given poll result output may be displayed in association with a “share” or similar interface member that, upon selection, allows a user to share the output through social media or other communication channel.

Generating Slide Documents and Other Documents with Poll Results

In an implementation, slide document generation engine 224 may generate a slide document (e.g., a PowerPoint® presentation graphics program document) that includes one or more poll result outputs. The slide document can be configured with various slides (or pages), each slide having one or more of the poll result outputs. In this manner, using system 100, a user may automatically generate slide presentations with embedded poll results outputs. As described herein, the term “slide document” will be used for convenience and illustration, but not limitation. Other types of documents, such as word processing documents, spreadsheet documents, PDF document, etc., may be generated by slide document generation engine 224 as well.

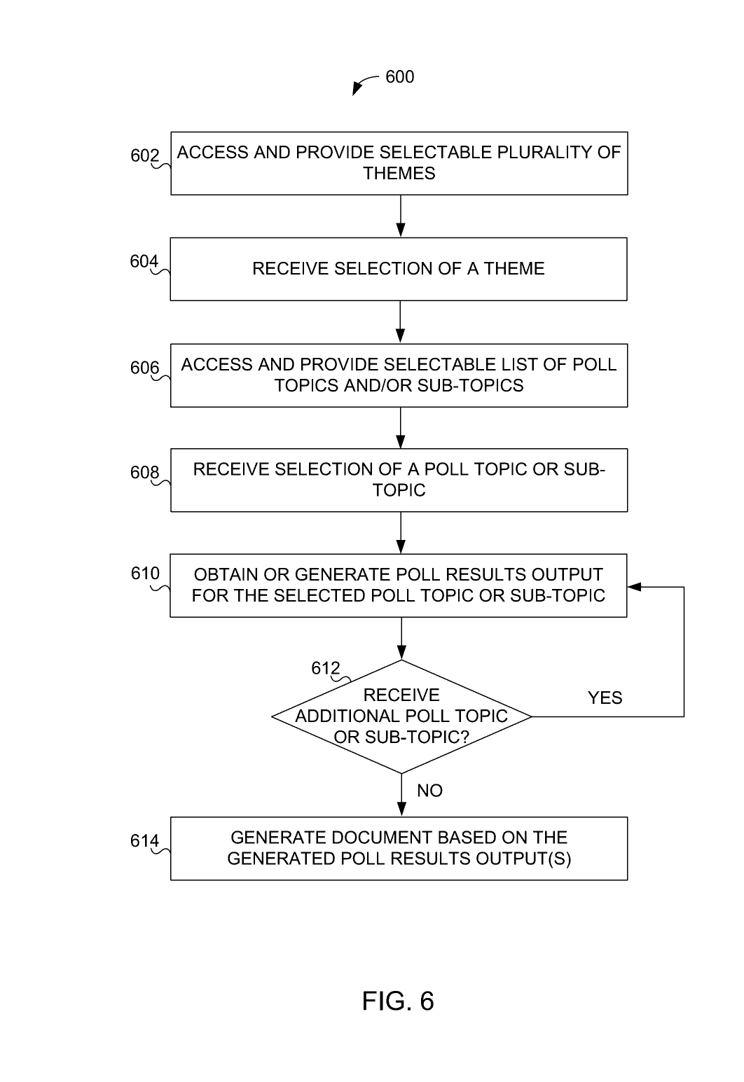

FIG. 6 illustrates a flow diagram of a process 600 for dynamically generating a slide document based on selectable polls, according to an implementation of the invention. Process 600 may be performed by slide document generation engine 224 and/or other component of system 100.

In an operation 602, process 600 may include accessing a plurality of themes and providing a selectable listing of the themes. The themes may be pre-stored in a themes database, such as a database 114. A given theme may include various appearance parameters that controls the appearance (e.g., colors, fonts, graphics, layout, orientation, etc.) of slide documents that use the given theme. Themes may be generic in that they are not customized for any given user or entity, or themes may be custom in that they have been generated or customized by a user or entity. For instance, custom themes may include corporate logos/graphics, and/or other customized appearance parameters.

In an operation 604, process 600 may include receiving a selection of a theme. For instance, a user may select a given theme they wish to use to generate a slide document.

In an operation 606, process 600 may include accessing a plurality of poll topics and/or sub-topics and providing a selectable listing of the poll topics/sub-topics. Such topics and sub-topics may be accessed based on all available topics/sub-topics or may be access based on a search query used to search for particular topics/sub-topics of interest.

In an operation 608, process 600 may include receiving a selection of a poll topic/sub-topic. For instance, a user may select a given poll topic so that results of the selected poll topic are included in the slide document. For instance, the user may select an “add to slide” button to indicate that a poll result output related to the selected poll topic should be added to a slide of the slide document. In some instances, a user may specify on which slide a given poll result output should be placed, as well as, or alternatively, a location on the slide. In some instances, process 600 may maintain a counter that counts the number of poll result outputs to be added to the slide document so that they may each be added in the order in which their corresponding poll topics are selected by the user. Alternatively or additionally, process 600 may generate a queue of poll result outputs so that they may be added in an order based on the queue. In some instances, one slide may be generated for each poll result output to be added.

In an operation 610, process 600 may include obtaining or generating one or more poll results outcome related to the selected poll topic/sub-topic. In instances where the poll results outcome for the poll topic/sub-topic has been previously generated and stored (e.g., in a database 114), then process 600 may simply obtain access the poll results outcome. In instances where the poll results outcome is not previously stored or where custom filters are desired, process 600 may generate the one or more poll results outcome.

In an operation 612, process 600 may include determining whether additional poll topics or sub-topics have been selected. If additional topics or sub-topics have been selected, processing may return to operation 610 so that additional poll results outputs related to the additional topics/sub-topics may be added to the slide document.

In an operation 614, process 600 may include generating the slide document based on the poll result outputs related to the selected poll result topic(s)/sub-topic(s). As previously noted, the slide document may be generated based on location information specified by the user (e.g., slide number, location on a slide, etc.), based on an automatically generated counter or queue, and/or other technique.

Analyzing Polling Trends

In an implementation, trend analytics engine 226 may perform trend analysis on poll related information available to polling analytics system 102. For instance, trend analytics engine 226 may determine trends that indicate a popularity of a given poll topic, a set of poll topics, a subject matter of poll topics (e.g., politics-related, economy-related, technology-related, etc.) based on a number of times that each have been accessed, saved or shared (e.g., through starring and sharing engine 222), etc. In this manner, trend analytics engine 226 may determine what types of poll results are popular among users or entities that generate poll result outputs using the system.

In some instances, trend analytics engine 226 may determine trends related to poll results themselves. For instance, trend analytics engine 226 may determine, from the poll results available through polling system 101, that sentiment relating to a topic is increasing, decreasing, or remaining the same (statistically speaking) for a given time period. For instance, trend analytics engine 226 may detect an upward (or downward) trend in consumer confidence over the last six months by analyzing polling results related to consumer confidence within the last six months.

Whichever type of trends are determined, trend analytics engine 226 may cause a poll result output to be generated that illustrates the trend. For instance, a poll result output may be generated that includes a graph of the trend over time. In some of these instances, the trend may be compared to a trend or other poll results from a prior point in time. For instance, the trend may be compared to consumer sentiment from the same period of time from a prior year, and both sets of trends or data may be overlaid onto a single poll result output for comparison.

In an implementation, trend analytics engine 226 may determine trends based on respondent demographics (e.g., gender, residence location, etc.), geography pertaining to a poll (e.g., poll questions related to different geographic locations), and/or other characteristic of the poll data.

Examples of GUIs and Poll Result Outputs

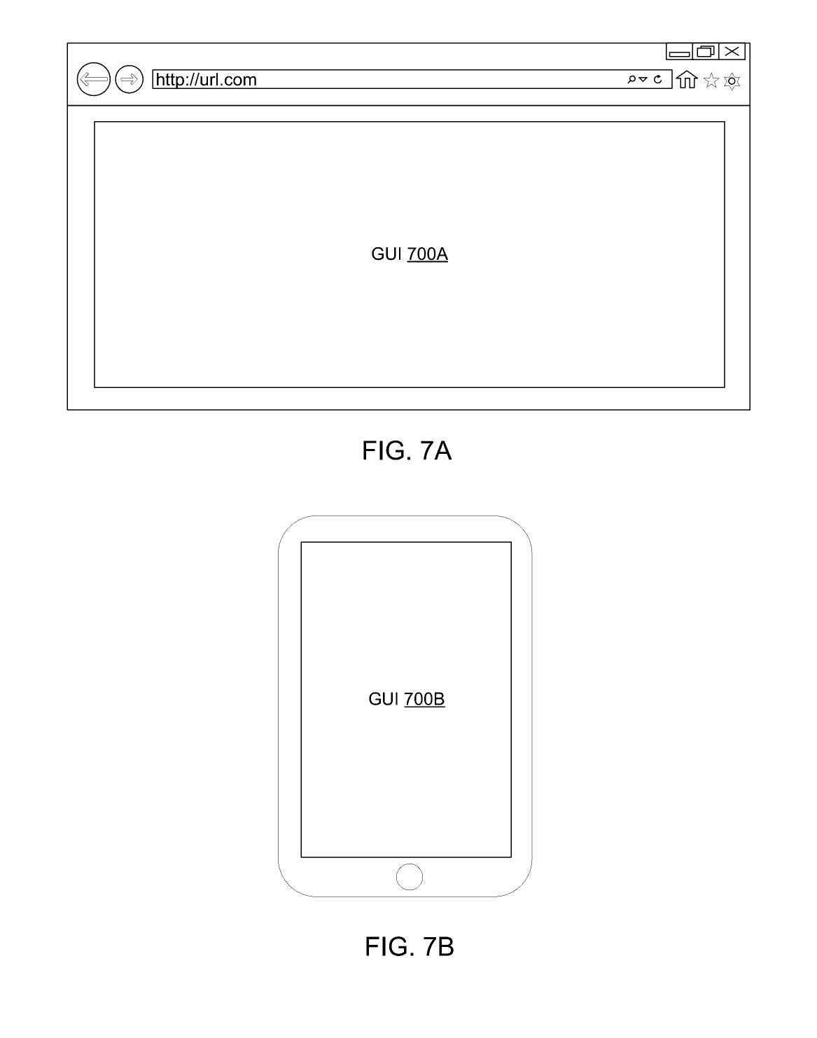

FIG. 7A illustrates a channel through which the poll results output may be presented to a user, according to an implementation of the invention. FIG. 7A illustrates a browser being used to display GUI 700A, which may include an interface through which a poll result output is provided. FIG. 7B illustrates a channel through which the poll results output may be presented to a user, according to an implementation of the invention. FIG. 7B illustrates an end user device (e.g., a mobile deice) that includes an application (e.g., a mobile “app”) that displays GUI 700B, which may include an interface through which a poll result output is provided.

GUI 700A, GUI 700B, and/or other GUI may be used to provide the various user interfaces described herein. Various other types of channels (e.g., electronic mail, MMS, and/or other channel that can convey electronic information) may be used to convey a poll result output as well.

Whichever type of GUI (or channel) is used, polling analytics computer system 110 may generate poll result outputs and provide such outputs for display through the GUI. Furthermore, polling analytics computer system 110 may receive, through the GUI, various inputs to modify a poll result output or to obtain a new poll result output. For instance, a user, through the GUI, may input additional parameters that can be used to update or otherwise replace a given poll result output, as described herein.

Alternatively or additionally, polling analytics computer system 110 may provide, to end user device 140, client-executed instructions (e.g., JAVASCRIPT, FLASH, etc.) to generate a given poll result output. Such instructions may include rules for modifying the poll result output. As would be appreciated, agents (e.g., a web browser that interprets JAVASCRIPT, a FLASH plugin that reads FLASH instructions, etc.) executing at an end user device 140 may receive the instructions from polling analytics computer system 110 and render a poll result output accordingly. Other types of technologies may be used as well, such as proxies that communicate information between polling analytics computer system 110 and end user device 140.

Having provided a non-limiting overview of the ways in which the various poll results outputs may be displayed to a user, attention will now turn to examples of various interfaces that include the outputs.

FIG. 8 illustrates a screenshot of a user interface 800 for providing selectable poll topics, according to an implementation of the invention. Section 802 may be used to input one or more search parameters, such as search terms, date filters, and/or other parameters. Portion 804, 808 may present a selectable listing of poll topics, which may include poll questions. Each poll question may be associated with a poll results output (illustrated as bar graphs, although other types of poll results output may be alternatively or additionally included). Sections 806, 810 may include an “ANALYZE” input member (e.g., button) that, when selected, causes poll results outputs to be provided. For instance, upon selection of the ANALYZE input member, polling analytics computer system 110 may analyze poll results and generate a poll result output and/or may obtain a pre-generated poll result output from a memory.

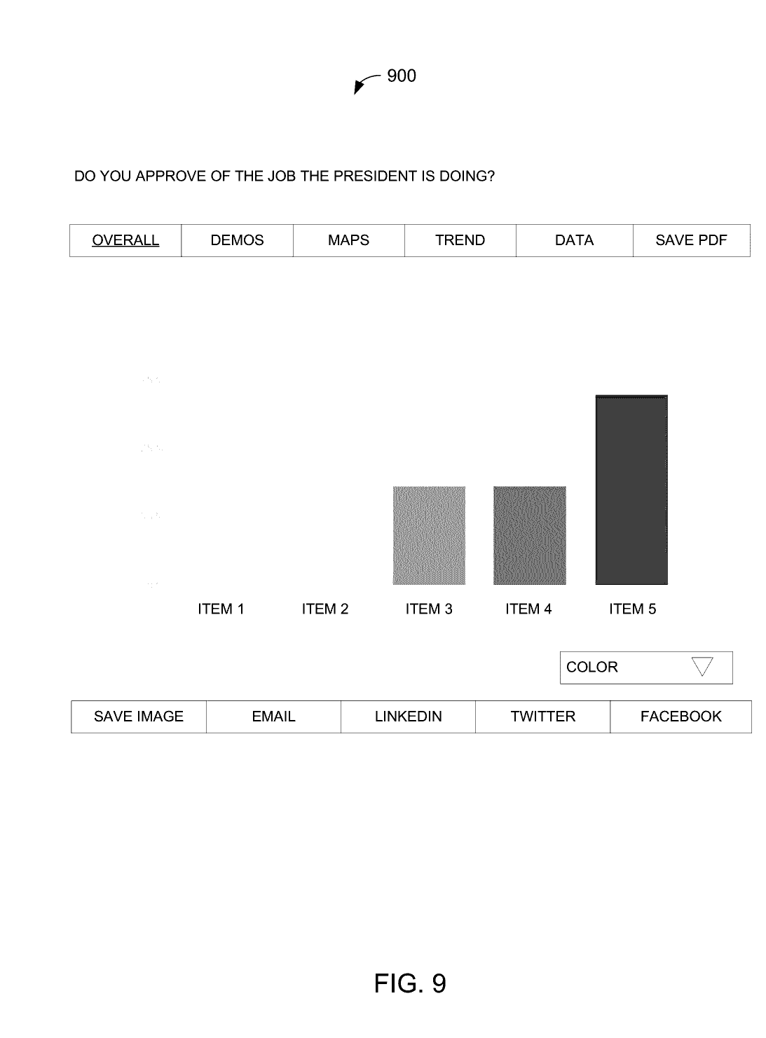

FIG. 9 illustrates a screenshot of a user interface for providing a display mode 900 of a poll results output, according to an implementation of the invention. As illustrated, display mode 900 displays a poll results output configured as a bar graph.

The “OVERALL” member, when selected (as illustrated), may provide poll results for all respondents.

The “DEMOS” member, when selected, may allow a user to select demographics or other filters for modifying the poll result output.

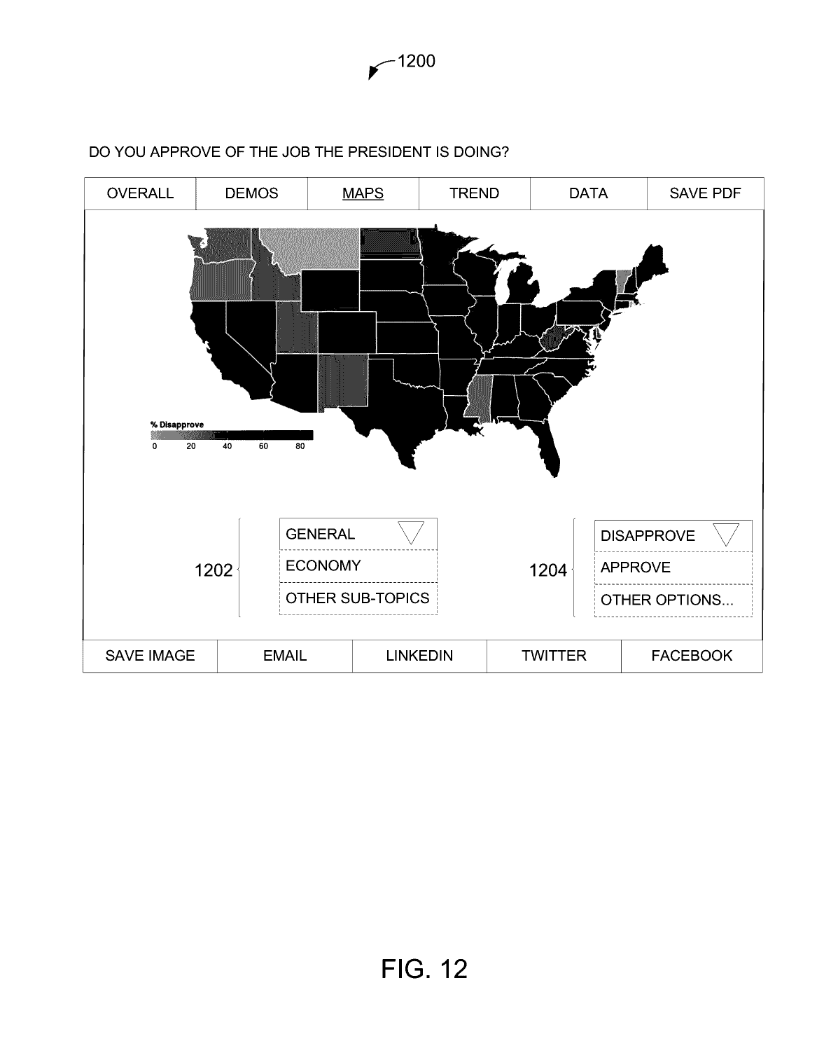

The “MAPS” member, when selected, causes display mode 1200, illustrated in FIG. 12, to be displayed.

The “TRENDS” member, when selected, causes a trend analysis to be conducted on the poll results corresponding to the displayed poll results output.

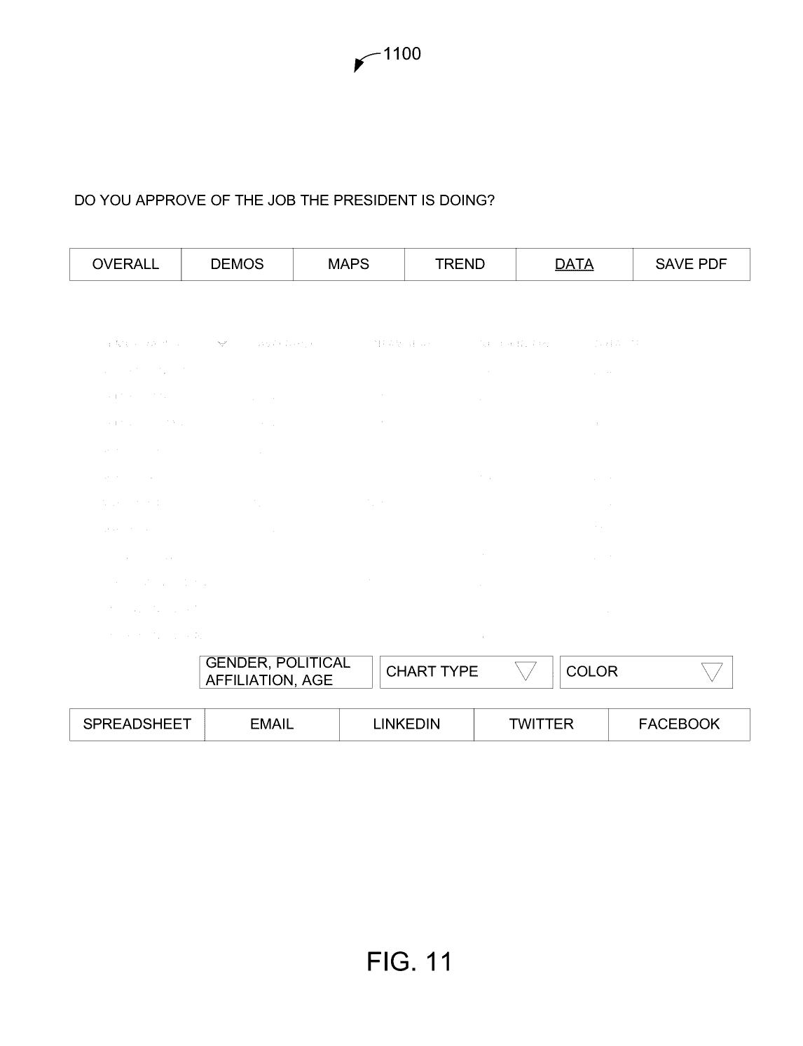

The “DATA” member, when selected, causes display mode 1100, illustrated in FIG. 11, to be displayed.

The “SAVE PDF” member, when selected, causes the poll results output to be saved locally as a PDF file.

The “SAVE IMAGE” member, when selected, causes the poll results output to be saved locally as an image file. The SAVE PDF and SAVE IMAGE related functions are not to be confused with the favorites function described herein, in which a poll results output to be saved in association with a given user.

The “EMAIL” member, when selected, causes the poll results output to be emailed to an email address (which may be later input by the user or may be pre-stored).

The “LINKEDIN” member, “TWITTER” member, or “FACEBOOK” member, when selected, causes the poll results output to be shared via a corresponding social media platform 120.

The “COLOR” member, may allow the user to change the color of the poll results output. Other visual features may be changed as well (e.g., size, orientation, etc.).

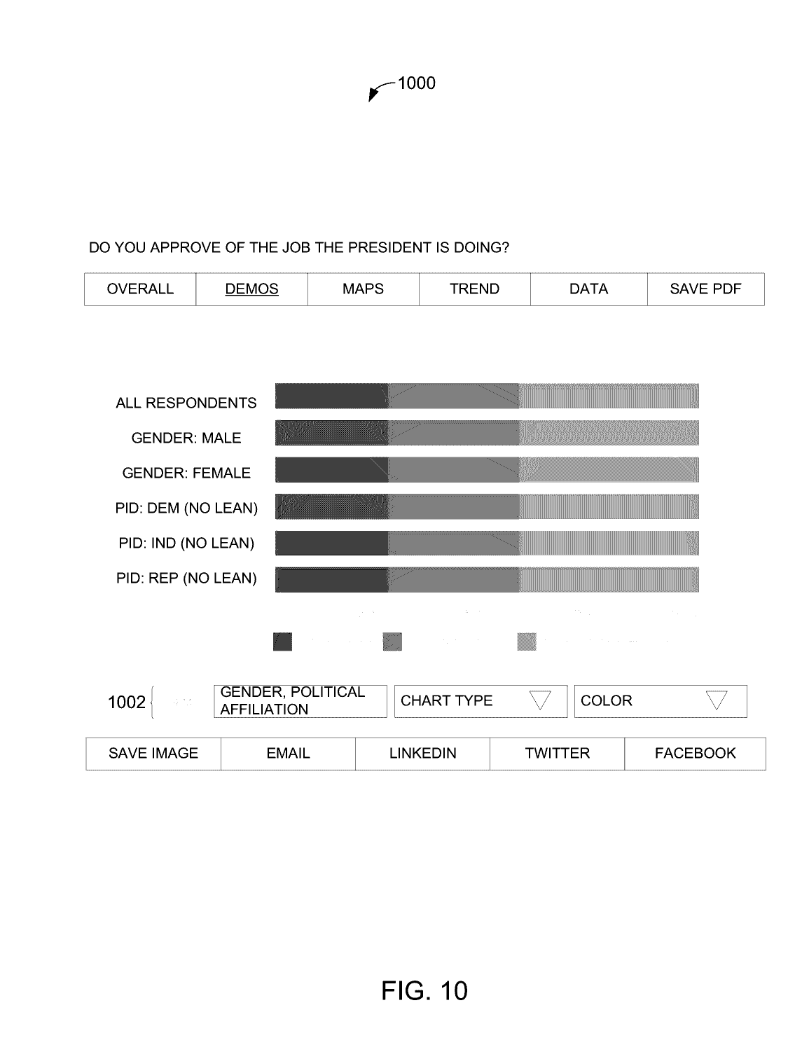

It should be noted that interface members that appear in FIG. 9 (as described above) and in other drawing figures (e.g., FIGS. 10-13) will have similar functionality.

FIG. 10 illustrates a screenshot of a user interface for providing a display mode 1000 of a poll results output based on respondent characteristics, according to an implementation of the invention.

As illustrated, display mode 1000 displays a poll results output configured as a bar graph that shows a breakdown of responses based on respondent characteristics, such as gender and political affiliation. Although not illustrated, the breakdown may include a combination of characteristics such as by gender and political affiliation. Responses based on other respondent characteristics may be similarly displayed, either individually, or in combination with one or more other characteristics.

Portion 1002 may include an input member that allows a user to input filter parameters to add or remove characteristics. As illustrated, “GENDER” and “POLITICAL AFFILIATION” have been input. As additional filter parameters are added, poll results output may be dynamically updated to reflect the additional filter parameters. For instance, a user may input “AGE” to add an additional bar graphic relating to respondents based on their age.

FIG. 11 illustrates a screenshot of a user interface for providing a chart display mode 1100 for providing a poll results output, according to an implementation of the invention. In the illustrated display mode, poll results are provided in a chart, or tabular, format.

As illustrated, “GENDER,” “POLITICAL AFFILIATION,” “AGE,” and “ETHNICITY” have been input as filters to display poll results. As additional filter parameters are added, the chart may be dynamically updated to reflect the additional filter parameters.

FIG. 12 illustrates a screenshot of a user interface for providing a map display mode 1200 for providing a poll results output, according to an implementation of the invention. In the illustrated display mode, poll results are provided in a map format.

As illustrated, map display mode relates to a topic (as illustrated, approval of the President) and one of a plurality of sub-topics (as illustrated, “GENERAL,” “ECONOMY,” and/or other sub-topics). Portion 1202 may be used to select a given sub-topic. Responsive to such as selection, the poll results output may be updated to reflect responses to particular sub-topic. Portion 1204 may be used to view particular responses. For instance, a user may select “DISAPPROVE” to view a map of results of respondents who disapprove of the President's “GENERAL” performance.

A user may select “DISAPPROVE” and “ECONOMY” to view a map of results of respondents who disapprove of the President's performance relating to the economy. Likewise, a user may select “APPROVE” to view a map of results of respondents who approve of the President's “GENERAL” performance. Of course, a sub-topic may be omitted so that the user may simply view results relating to the topic. Likewise, other sub-topics may be added so that the user may view results of additional sub-topics.

Although not illustrated, two or more of the various display modes illustrated in FIGS. 9-12 may be combined into a single display or otherwise be presented simultaneously. For instance, display mode 900 may be displayed along with display mode 1000. Other numbers and combinations of display modes may be displayed together as well.

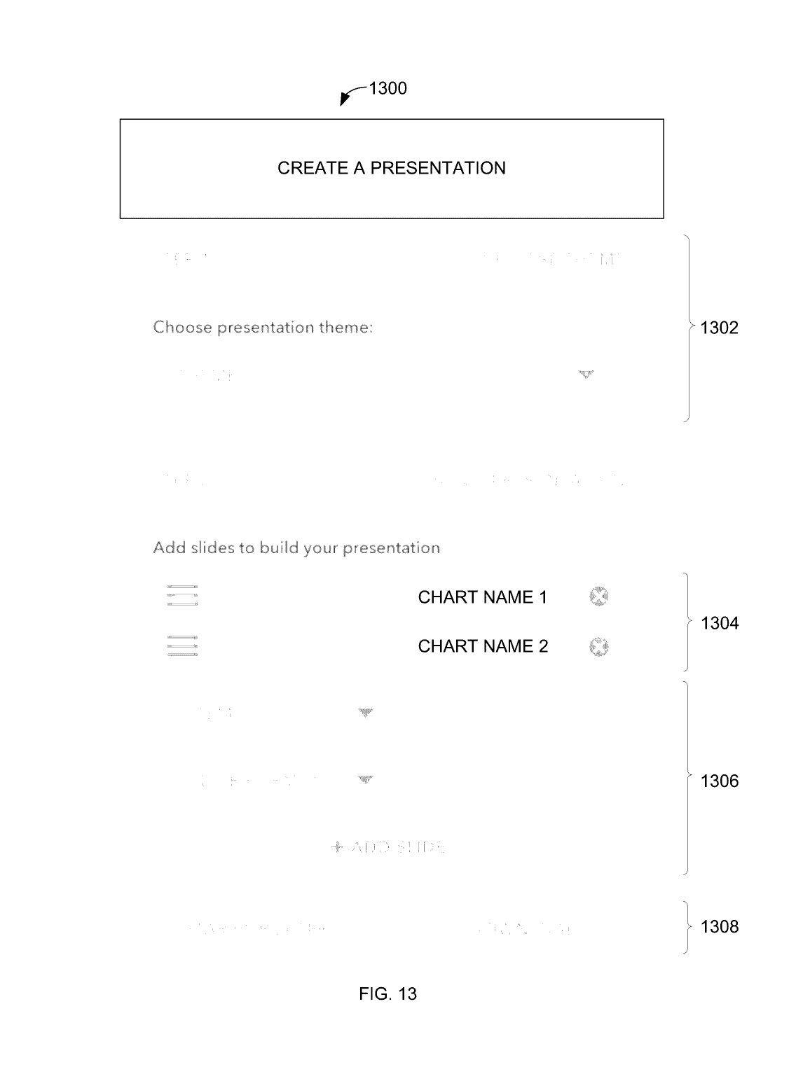

FIG. 13 illustrates a screenshot of a user interface 1300 for generating slide documents that include poll result outputs, according to an implementation of the invention. Inputs received via user interface 1300 may be used by slide generation engine 224 (and/or other components of polling analytics computer system 102).

Portion 1302 may present an interface member to select a theme for the generated slide. (e.g., “CHART NAME 1” for a first chart and “CHART NAME 2” for a second chart; other types of poll results outputs may be named and used as well). Portion 1306 may present an interface member to select an item (e.g., results of a poll topic or sub-topic) to add, an interface member to select a slide format, and an interface member to add a slide to the slide document. Upon selection of an item, a corresponding poll result output will be generated and added to a given slide upon activation of the “ADD SLIDE” interface member. A name of the poll results output (e.g., “CHART NAME 1” for a first chart and “CHART NAME 2” for a second chart; other types of poll results outputs may be named and used as well) may be used based on input values associated with portion 1306.

Portion 1308 may present an interface member “STAR FOR LATER” to star a slide document in association with user identifying information. Portion 1308 may present an interface member “DOWNLOAD” to download a slide document. Other interface members (not illustrated) may be included to share the slide document via email, MMS, social media platforms 120, content sites 130, and/or other channel.

End User Devices 140

End user device 140 may be configured as a personal computer (e.g., a desktop computer, a laptop computer, etc.), a smartphone, a tablet computing device, and/or other device that can be programmed to interface with polling analytics system 102. Although not illustrated in FIG. 1, end user devices 140 may include one or more physical processors programmed by computer program instructions.

Although illustrated in FIG. 1 as a single component, computer system 110 and end user device 140 may each include a plurality of individual components (e.g., computer devices) each programmed with at least some of the functions described herein. In this manner, some components of computer system 110 and/or end user device 140 may perform some functions while other components may perform other functions, as would be appreciated. The one or more processors 212 may each include one or more physical processors that are programmed by computer program instructions. The various instructions described herein are exemplary only.

Other configurations and numbers of instructions may be used, so long as the processor(s) 212 are programmed to perform the functions described herein.

Furthermore, it should be appreciated that although the various instructions are illustrated in FIG. 1 as being co-located within a single processing unit, in implementations in which processor(s) 212 includes multiple processing units, one or more instructions may be executed remotely from the other instructions.

The description of the functionality provided by the different instructions described herein is for illustrative purposes, and is not intended to be limiting, as any of instructions may provide more or less functionality than is described. For example, one or more of the instructions may be eliminated, and some or all of its functionality may be provided by other ones of the instructions. As another example, processor(s) 212 may be programmed by one or more additional instructions that may perform some or all of the functionality attributed herein to one of the instructions.

The various instructions described herein may be stored in a storage device 214, which may comprise random access memory (RAM), read only memory (ROM), and/or other memory. The storage device may store the computer program instructions (e.g., the aforementioned instructions) to be executed by processor 212 as well as data that may be manipulated by processor 212. The storage device may comprise floppy disks, hard disks, optical disks, tapes, or other storage media for storing computer-executable instructions and/or data.

The various databases 114 described herein may be, include, or interface to, for example, an Oracle™ relational database sold commercially by Oracle Corporation. Other databases, such as Informix™, DB2 (Database 2) or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The database may store a plurality of types of data and/or files and associated data or file descriptions, administrative information, or any other data.

The various components illustrated in FIG. 1 may be coupled to at least one other component via a network, which may include any one or more of, for instance, the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network. In FIG. 1, as well as in other drawing Figures, different numbers of entities than those depicted may be used. Furthermore, according to various implementations, the components described herein may be implemented in hardware and/or software that configure hardware.

The various processing operations and/or data flows depicted in FIG. 3 (and in the other drawing figures) are described in greater detail herein. The described operations may be accomplished using some or all of the system components described in detail above and, in some implementations, various operations may be performed in different sequences and various operations may be omitted. Additional operations may be performed along with some or all of the operations shown in the depicted flow diagrams. One or more operations may be performed simultaneously. Accordingly, the operations as illustrated (and described in greater detail below) are exemplary by nature and, as such, should not be viewed as limiting.

Other implementations, uses and advantages of the invention will be apparent to those skilled in the art from consideration of the specification and practice of the invention disclosed herein. The specification should be considered exemplary only, and the scope of the invention is accordingly intended to be limited only by the following claims.

1. A computer implemented method of analyzing poll results and providing dynamic poll results outputs, the method being implemented in a computer system having one or more physical processors programmed with computer program instructions that, when executed by the one or more physical processors, cause the computer system to perform the method, the method comprising:
accessing, by the computer system, a first response to a poll question relating to a particular topic, the first response being stored in a physical memory in association with first respondent information that includes a plurality of first characteristics of a first respondent from which the first response was received;
accessing, by the computer system, a second response to the poll question, the second response being stored in the physical memory in association with second respondent information that includes a plurality of second characteristics of a second respondent from which the second response was received;
generating, by the computer system, a poll result output based on the first response and the second response;
causing, by the computer system, the poll result output to be presented via a graphical user interface;
receiving, by the computer system, a request to add secondary information to the poll result output;
identifying, by the computer system, a location on the poll result output on which to overlay the secondary information based on one or more characteristics of the poll result output;
responsive to the request, causing, by the computer system, the secondary information to be overlaid onto the poll result output based on the identified location; and
causing, by the computer system, instructions to be provided to the end user device, wherein the instructions configure the end user device to receive one or more further requests to change the poll result output and further update, at the end user device, the poll result output upon receipt of the one or more further requests without providing the one or more further requests to the computer system.

2. The method of claim 1, wherein the secondary information is related to the poll question, but is not a response to the poll question from a respondent.

3. The method of claim 2, wherein the secondary information comprises economic data that is overlaid onto the poll result output.

4. The method of claim 1, wherein causing the secondary information to be overlaid onto the poll result output comprises causing a new poll result output that includes the secondary information overlaid onto the poll result output to be generated, or modifying the poll result output.

5. The method of claim 1, the method further comprising:
receiving, by the computer system, one or more filter parameters;
modifying, by the computer system, the poll result output based on the one or more filter parameters; and
causing, by the computer system, the modified poll result output to be provided.

6. The method of claim 1, the method further comprising:
accessing, by the computer system, a plurality of user-selectable themes comprising one or more appearance parameters;
providing, by the computer system, a listing of the plurality of user-selectable themes;
receiving, by the computer system, a selection of a theme;
generating, by the computer system, a slide for a slide document based on the selected theme;
including, by the computer system, the poll result output in the slide; and
generating, by the computer system, a slide document including the slide.

7. The method of claim 1, the method further comprising:
receiving, by the computer system, from a user, an indication to save the poll result output;
obtaining, by the computer system, user identifying information that identifies the user;
saving, by the computer system, an association of the poll result output and the user identifying information that identifies the user responsive to the receipt of the indication;
receiving, by the computer system, from the user, a request to view saved poll result outputs previously saved in association with the user;
identifying, by the computer system, the poll result output based on the association of the poll result output and the user identifying information that identifies the user; and
causing, by the computer system, the poll result output to be provided to the user responsive to the request to view the saved poll result outputs.

8. The method of claim 1, the method further comprising:
receiving, by the computer system, from a user, a request to share the poll result output through a social media account of the user; and
causing, by the computer system, the poll result output to be posted to the social media account responsive to the request to share the poll result output through the social media account of the user.

9. The method of claim 1, the method further comprising:
receiving, by the computer system, from a user, a request to share the poll result output;
accessing, by the computer system, an email address or phone number through which to share the poll result output; and
causing, by the computer system, the poll result output to be transmitted via the email address or via the phone number.

10. The method of claim 1, wherein the poll result output comprises a geographic map view that displays filtered poll responses based on locations of respondents.

11. A system of analyzing poll results and providing dynamic poll results outputs, comprising:
a computer system having one or more physical processors programmed with computer program instructions that, when executed by the one or more physical processors, cause the computer system to:
access a first response to a poll question relating to a particular topic, the first response being stored in a physical memory in association with first respondent information that includes a plurality of first characteristics of a first respondent from which the first response was received;
access a second response to the poll question, the second response being stored in the physical memory in association with second respondent information that includes a plurality of second characteristics of a second respondent from which the second response was received;
generate a poll result output based on the first response and the second response;
cause the poll result output to be presented via a graphical user interface;
receive a request to add secondary information to the poll result output;
identify a location on the poll result output on which to overlay the secondary information based on one or more characteristics of the poll result output;
responsive to the request, cause the secondary information to be overlaid onto the poll result output based on the identified location; and
cause instructions to be provided to the end user device, wherein the instructions configure the end user device to receive one or more further requests to change the poll result output and further update, at the end user device, the poll result output upon receipt of the one or more further requests without providing the one or more further requests to the computer system.

12. The system of claim 11, wherein the secondary information is related to the poll question, but is not a response to the poll question from a respondent.

13. The system of claim 12, wherein the secondary information comprises economic data that is overlaid onto the poll result output.

14. The system of claim 11, wherein to cause the secondary information to be overlaid onto the poll result output, the computer system is further programmed to:
cause a new poll result output that includes the secondary information overlaid onto the poll result output to be generated, or modifying the poll result output.

15. The system of claim 11, wherein the computer system is further programmed to:
receive one or more filter parameters;
modify the poll result output based on the one or more filter parameters; and
cause the modified poll result output to be provided.

16. The system of claim 11, wherein the computer system is further programmed to:
access a plurality of user-selectable themes comprising one or more appearance parameters;
provide a listing of the plurality of user-selectable themes;
receive a selection of a theme;
generate a slide for a slide document based on the selected theme;
include the poll result output in the slide; and
generate a slide document including the slide.

17. The system of claim 11, wherein the computer system is further programmed to:
receive, from a user, an indication to save the poll result output;
obtain user identifying information that identifies the user;
save an association of the poll result output and the user identifying information that identifies the user responsive to the receipt of the indication;
receive from the user, a request to view saved poll result outputs previously saved in association with the user;
identify the poll result output based on the association of the poll result output and the user identifying information that identifies the user; and
cause the poll result output to be provided to the user responsive to the request to view the saved poll result outputs.

18. The system of claim 11, wherein the computer system is further programmed to:
receive, from a user, a request to share the poll result output through a social media account of the user; and
cause the poll result output to be posted to the social media account responsive to the request to share the poll result output through the social media account of the user.

19. The system of claim 11, wherein the computer system is further programmed to:
receive, from a user, a request to share the poll result output;
access an email address or phone number through which to share the poll result output; and
cause the poll result output to be transmitted via the email address or via the phone number.

20. The system of claim 11, wherein the poll result output comprises a geographic map view that displays filtered poll responses based on locations of respondents.

21. The method of claim 1, wherein the one or more characteristics of the poll result output comprise a size of the poll result output.

22. The method of claim 1, wherein the one or more characteristics of the poll result output comprise a time scale of the poll result output.

23. The method of claim 1, wherein the one or more further requests comprise at least a first further request to change a mode of the poll result output.
